(19) United States
(12) Patent Application Publication
(10) Pub. No.: US 2009/0140037 A1
(43) Pub. Date: Jun. 4, 2009

(54) MANAGEMENT SYSTEM FOR CODE ESTABLISHMENT OF UBIQUITOUS PERSONALIZATION SERVICE AND SERVICE METHOD THEREOF

(76) Inventor: Seoung-Lan Lee, Daejeon (KR)

Correspondence Address: SHERR & VAUGHN, PLLC, 620 HERNDON PARKWAY, SUITE 200, HERNDON, VA, 20170, US

(21) Appl. No.: 12/300,354

(22) PCT Filed: May 8, 2007
(86) PCT No.: PCT/KR2007/002245

§ 371 Date: Nov. 11, 2008

(30) Foreign Application Priority Data
May 11, 2006 (KR) 10-2006-0042189

(51) Int. Cl. G06F 17/00

(52) U.S. Cl. 235/375

(57) ABSTRACT

It covers personalization code configuration & management system realizing the individual personalization achievement with wired & wireless internet convergence, information telecommunication convergence, financial convergence, the other online-offline convergence, and its methods to provide services. This invention performs coding customer information in a personalization manner, and provides various code patterns to the existing coding medium such as bar-code, RFID, image code, and color code, and in addition, if a customer sets up a code pattern of the most desired personalization information, it provides a utilized terminal with personalization information according to the personalization menu with consideration of personal preferences including place, time, utilizing terminals, and circumstances.

### TECHNICAL FIELD

The former information providing method which codes had been utilized mainly focuses on code system to connect to the web-site and properly purchase items, mainly with code patterns such as bar code, image code, and RFID, yet it seeks to only provide personalization information limited within personally limited range. The following examples are indicated below.

### Domestically Opened Patent No. 10-2004-0079625 and 10-2004-0081890:

Supposing that a customer connect to a indicated web-site as soon as user's terminal detects and takes images of code patterns with the utilization of user's terminal, the indicated web-site judges whether codes are in matchable accordance with previously set-up contents or electronic commerce, and certain information matched with the codes are allowed for user's terminal to transmit them.

Conversely, this invention has merits that even toward the same code pattern, personalization information can be provided individually according to the subjective on by whom a certain code pattern are utilized, other than the former merit, it has variety of progressive characteristics such as various personalization information configuration systems and a system for limiting information connection.

### BACKGROUND ART

Total Convergence, Personalization Service, Ready-made Information, rCode Pattern

### DISCLOSURE OF INVENTION

### Technological Problems

As regulations have softened recently for comprehensive competitiveness in the society, Internet big-bang and financial big-bang are being progressed favorably. With acute influence of two big-bangs, within entire domains of personal daily lives, converged big-bangs such as education big-bang, cultural big-bang, and marketing big-bang are also expected to making rapid progress. Therefore, with enterpriser perspective regarded with business environment, it is timely required for them to construct effective business model in the total convergence environment being suitable with converged big-bangs. Besides, it has been convenient with perspective of personal life environment, yet, methods to solve the following problems effectively in a personalization way are required.

First of all, individually personalization services have been recognized as the main stream in the entire aspects of industries, yet personalization catering to customer's various needs is limited and insufficient to satisfy them. To provide individually personalization services in light of user's stance, it is required to construct personalization portal which incorporates both on-line and off-line medium in the comprehensive personal life, enhance the essential values and qualities of personal daily lives gradually with cooperative connection of cell phone, personal computer, IPTV, newspaper, and books through only a membership, and provide personalization satisfaction according to the diverged taste.

It is also requisite to provide the entire part of total personalization functions; one function is recognized as “personal secretary” providing not only time minimization, achievements for convenience, and excitement but also individual competitiveness, and pleasure according to the personal taste, and the other function is recognized as “a portal being in charge as mentor” providing personalization services mainly concerned with information, commodities' choice, choice of internet connection limitation, habits and human relationship, mental culture, convenient life, rating, tendencies of users, competitiveness, and economic efficiency.

Secondly, There are lots of customers that can't properly use wired internet, even regardless of the use of wireless internet. Especially, in terms of wireless internet, since there are groundless focuses and negative realities for increasing demands such that its input and output functions are inconvenient, its functions of using information has unfavorable difficulties to be familiar with, and shortage of its essential services is recognized as awkward compared with its high communication expense, it is desperately crucial to develop new services to unravel these tangled-up problems.

Thirdly, it is also required to construct a personalization function that provide internet information being full of harmfulness, unsuitability, and groundlessness which have been recognized as Achilles' hill for expanding the information telecommunication and on-line market, For now, long-term focuses for Internet expansion looks ambiguous with refusal of parental use. Therefore, since this invention seeks to solve the following problems mentioned above, it covers personalization code configuration & management system realizing the individual personalization achievement with convergence bases of wired&wireless internet convergence, information telecommunication convergence, financial convergence, the other online-offline convergence, and its methods to provide services.

This invention performs coding customer information in a personalization manner, and provides various code patterns to the existing coding medium such as bar-code, RFID, image code, and color code, and in addition, if a customer sets up a code pattern of the most desired personalization information, it provides a utilized terminal with personalization information according to the personal personalization menu with consideration of personal preferences including place, time, utilizing terminals, and circumstances.

In addition, the other purpose of this invention is that even though users don't know about or are not familiar with the computer, but if a user put a interest code searched by code directory similar with either phone directory or life information magazine on camera of his or her cell phone, The desired information is personalization according to personal tastes like location, time, place, and circumstance during the day, and it transfers automatically to his or her terminal without a hitch.

### Technical Solution Methods

To solve these mentioned problems, this invention strives to realize individually personalization solutions in total convergence basis.

Toward the entire scopes of information telecommunication, finances, education, newspapers, and shopping closely related with personal life, in the total convergence environment with SSO—Single Sign on basis, a cell phone becomes the scheduler for individually total personalization information, and provides information cooperating with off-line mediums such as wired-and-wireless Internet, IPTV, newspaper and books.

In the cases of delivery, there is a on-line personalization delivery and off-line co-related delivery. In terms of on-line personalization delivery, connection delivery, reservation delivery, and saving delivery can be done according to time, place, and circumstance personalization menu in either everywhere or the core of mainly utilized places from waiting screen of cell-phone, PC screen, IPTV screen. Additionally, in terms of off-line co-related delivery, personalization delivery is performed and can be used as the form of original newspaper through cooperation with newspaper, cell phone, PC, and IPTV after inputting off-line co-related code indicated in the off-line co-related menu included by newspaper and books.

In personalization delivery, to use expanded information rather than a information usage simplified by one's cell phone, connection delivery is done by interrelating the present place with either one's or other's PC or one's or other's IPTV and taking delivery of information.

In terms of reservation delivery, to also use expanded information rather than a information usage simplified by one's cell phone, it is also done not by making utilization from the present place but by taking co-related delivery from PC or IPTV indicated by the mainly-used place. In terms of saving delivery, to use personalization delivery in the area not connected with wireless internet network, this delivery is done with internal or outer memory basis by delivering partial information taken up by the large capacities into one's cell phone in advance and transmitting in accordance with personalization menu.

Utilizing the personalization menu code recognized as storage utility basis, the accordingly information can be utilized toward existing information. Indication and utilization can be done after setting-up personalization information field to use personal menu personalization code according to the place and constitute of menu pattern. Finally, personal realization concerned with purpose standards can be performed with active pop-up and inert pop-up according to the place.

### Personalization Code Configuration & Management System

The FIG. 1 is the organization chart of personalization configuration & management system of this information.

personalization code configuration & management of this invention constitutes of various personalization code for configurating various customer personalization conditions, sorts of code patterns having on-line and off-line cooperation code(10) to co-relate terminals with mediums between on-line and off-line, networks(20), personalization code configuration & management system department(30), web server(40), customer terminals(100), and portable terminals(200).

The FIG. 2 is the organization chart of personalization code configuration & management system department(30).

personalization code configuration & management system department(30) constitutes of personalization information pool server(300), personalization code configuration & management department(400), information processing & distribution department(500), code-creator management department(600), code pattern analysis department(700), location management department(800), personal saving information department(900), database management department(1000), personalization information pool management department(1100), delivery & receipt department(1200).

The following code pattern(10) enables itself to perform bar code, image code, colour code, hot code, and RFID code.

The following networks(20) enables itself to perform wired internet, and wireless internet.

The following web server(40) is a computer constructed for information provider taking holds of personalization information and their related information by calculating the relation according to customer-to-customer personalization menu in the personalization information pool, therefore, to give more specific details in personalization information located within the detailed personalization menu of customer terminal, it stores the detailed information provided by indicated information provider by utilization of connection delivery, reservation delivery, detailed-use delivery.

The following customer terminal(100) and cell-phone terminal(200)—these collective devices were called as “customer terminal”-configurate various personalization code, set-up co-relating code between on and off, between terminals, and between on-off and terminals, performs the order of various information processing input, transmits personalization processing information and personalization information from configuration & management system department(30), takes delivery of personalization information and expresses them.

The following personalization information pool server(300) is mentioned as the computer that manages various personalization product information and personalization information which should be provided for customers in the form of pool according to the field, it is in charge of the creation and management of Pool and is taken care by personalization information pool management department(1100) in order to provide personalization information effectively toward personalization information field discriminated by detailed personalization sectors.

In addition, the following personalization code configuration & management department(400) comply accordingly configuration & management of personalization code, and its creation and management of code pattern(10) with its related function processing department through information processing distribution department(500).

Also, the following information processing distribution department(500) plays crucial role as the supervision of personalization configuration & management system department including various information processing demand messages transmitted by customer terminal, and transmits the related information processing toward function processing department after analyzing information processing distinguisher included in the messages which were mentioned above. The function processing department constitutes of configuration & management department(400), code creator-management department(600), code pattern analysis department(700), location management department(800), personal saving information management department(900), database management department(1000), personalization information pool management department(1100), delivery department(1200).

Additionally, the following code-creator management department(600) takes in charge of applying for issuing codes to personalization code configuration & management department(400), acquires code patterns of these codes, and then inserts these to the following code-expression media or transmits them into terminals on their own.

Similarly, the following code pattern analysis department(700) takes the responsibility for customers that unless a certain decoder decoding code pattern(10) located in the customer terminal is constructed, by code pattern acquisition department(120), it takes the delivered messages of code-information, extracts them, and provides them after co-relating various information processing demand message(50).

Moreover, the following location management department(800) takes delivery of position verification processing demand messages from each customer, and makes it efficient to utilize user position-related datum which personalization information, menu, and terminals can be determined in respective position, after it adapts datum—wireless transmitter, wireless LAN, MAC ID, position data within certified location which divides them into suitable parts for customer within database management department(1000).

Also, the personally saving information management department(900) is in charge of saving and managing personal information according to the customer's information, corresponding the following information with database management department(1000) personally desired information to be saved among all of the transmitted information, certain information which enterpriser saves and manages, relating with popular information that corresponds with user personalization code, and finally information that are desirably saved, after creating contents as taken images, video information, and documents.

In addition, the following database management department(1000) is mentioned as a place managing various datum, co-relates itself with respective function-processing department. Database is specifically assorted and realize functionality according to respectively divided place. Also, the following personalization information and pool management department(1100) is mentioned as a place managing pool according to respectively personalization products or various personalization information, thereby co-relating its part with each function processing department. personalization information pool could be realized, after it being divided into the respective field and specified places.

Finally, the following delivery department(1200) performs a function which transmits various information processing demand messages and personalization information with customer terminal(100).

### Customer Terminal(100)

FIG. 3 is defined as the organization chart of customer terminal (100) indicated above FIG. 1

The following customer terminal constitutes of five parts including user interface department(110), code pattern acquisition department(120), position verification department(130). Decoder department(140), controlling & delivery department(150). To avoid the complexity for explaining FIG. 2, customarily-based terminals and their identical organizations are abridged, therefore, organization related to this invention was indicated.

User interface department(110) is defined as a part of means that provides interfaces between a certain customer and his or her terminals, and in order to connect to both personalization code configuration & management system department(30) and web server(40), it performs various functions that provides user interface, processes various personalization information, creates both demand messages, and indicates personalization information that is shown through both information screen interface by its terminal.

Code pattern acquisition department(120) performs the functions that it transmits certain acquired datum into decoder department(140) and personalization configuration & management system department(30), after acquiring various code pattern(10) including bar-code, and image-code. Code pattern acquisition department(120) can be organized into either external or internal forms made within customer terminals. Code pattern acquisition department(120) performs the functions that enables it to cover from scanner, PC camera, digital camera, web camera, and RFID reader.

Position verification department(130) performs a certain function that provides such customer's position-verified datum with user interface department(110), including GPS processing function, within terminals, and MAC ID from the transmitter or terminals. Decoder department(140) performs the function that extracts code-information with interpreting code pattern delivered from code pattern acquisition department(120). Decoder department(140) can be constituted of either one-dimension or two-dimension. Yet if the other reviewed, empirical examples are reviewed. Customer terminal may not include decoder department(140). Therefore, the providing service connected sequentially with this invention can be offered, utilizing customer terminal the constructed of the previous camera. In this case, the following reorganization for decoding to personalization code configuration & management system department should be included accordingly.

Controlling & delivery department(150) performs the function that takes delivery of the entire control-processing function within terminal, and receives various information processing demand messages, the internal part of personalization information from the user interface department(110), and transmit them into personalization code configuration & management system department(30) and web-server(40).

### Personalization Code Configuration & Management Department(400)

FIG. 4 is the organization chart of personalization code configuration & management department, as shown in the FIG. 4, it constitutes of configuration program saving department(410), configuration database department(420), and configuration processing department(430). To elude the complexity of empirical explanation in FIG. 4, the identical organization of customarily various management server devices is avoided, therefore its related organization of this invention was indicated.

personalization code configuration & management function is mentioned that this function is made up of code configuration which a certain customer uses through on-line code book by which various personalization codes can be set up, and the other code configuration that code pattern acquisition can be utilized within the code-book linked with other code books or chips, additionally it includes the function that code configuration is simultaneously done with cooperations between various terminals, including the first configuration of the code book that is done through terminal No. 1 which a certain customer utilizes and the other configuration that code pattern acquisition means could be utilized through the second terminal. Additionally, it supervises two code-qualities of personalization code from data table into database management system, and then it supervises the function of providing featured information in order to recognize simultaneously on personalization qualities when code pattern of personalization code is indicated, it is recorded on the code expression medium, ir it transmits them for the third party. It can be represented with either application program of terminals or data management program of supervising server of database management system(DBMS), and it can be realized through management server of data supervising program, and supervises code-qualities discriminated by the belonging field according to respective personalization codes.

The following configuration program saving department(410) plays a crucial role in supporting for configuration of various personalization codes, and saving and supervising operating programs, therefore configurated database department(420) performs the role in saving various datum. The following configuration processing department(430) plays a role in controlling and processing various programs and devices.

FIG. 5 is the chart of data structure of information processing demand message(50) on the conceptually-indicated basis.

As shown in FIG. 5, information processing demand message(50) is organized as the following recorded concepts including information processing distinguisher(51), terminal information(52), In terms of information processing related information(53). The following main-factors included on the messages of FIG. 5, suitable organization related to this invention was indicated in order to avoid its own complexity.

Information processing distinguisher(51) is mentioned as the part that records the types of information processing which configuration & management system department(30) must provide. It is the distinguisher that classifies various information that can be provided from configuration & management system department(30), it utilizes them according to the defined numbers of bit. According to the types of information processing, the number of bit could be decided. Information processing related information(53) is characterized as the field taking after necessary information incidentally derived from the performance of information processing.

Terminal information(52) is the original distinguisher that tell phone number of user's terminal apart from its own user.

Self-created data information is individually taken lively-created information, or is mentioned as the other created information, it could be included according to the types of messages.

The Definitions of Factor X, Y, and Z for Enhancing Personalization Development of Personal Competence

the development of human sensibility and the performance of mental habit & competence closely related to personally valuable and happy life have been gradually emphasized, after admitting the limitation and error to mental habit & competence development that had been previously oriented for the previous knowledge & capacity. This invention applies three competence development factors including Factor X, Factor Y, and Factor Z, in order to realize the methods of developing personalization individual-competence that determines the quality of the following total convergence, and both individual competitiveness and life qualities on individual personalization system basis.

First of all, mentioned as Factor X, it is the uprooting factor that is most likely to be based on the mental sensibility of the individual, it is a factor of competence that is mixed up with health-related factors, first of all, that are mainly concerned with emotion, sentiment, and belief, and additionally competence factors that are related to happy state, thankfulness, self-confidence, passion, pious-value, target-consciousness, and health consciousness. Factor Y is the factor that plays crucial role as either stem or branch among the core “columns” of mental sensibility, it is the mental-habit factors that are closely concerned with rational performance and deed, including deed, human performance, recognization and logics, and rational thinking, wise choice, standard and principle, human relationship, and human moral. Factor Z is mentioned as knowledge-competence oriented factor, and a factor that maintains on the basis of competence characteristics of Factor X and Factor Y, it is accordingly a factor playing a important role as leaf, fruit, and flower of the trees, in the Factor Z, it includes various factors like knowledge, interest, hobby, and essential factor field of daily lives such as information allocation and their index.

The Main Summary of Personalization Development Processes of Mental Capacities Among Individual Capabilities

The essentials of individual sensibility & competence capabilities are decided by learning competence, learning attitude, writing abilities, self-control performance, individual competitiveness, health-management competence, financial skills, and risk-taking abilities. Both Factor X and Factor Y belong to the factors that are concerned with individual mental habit, therefore they are mentioned as the decided factors that depends on two causes and nearly forms the frameworks with them: home surroundings before forming prior to the age of fifteen, and parents' acquired mental habit. And once formed, it is acutely difficult to alter the framework with their own recognization and much trial. Therefore, most of people connect either factors with religious life to improve them. However religious they may be, it could be mentioned as the main characteristics that incorrectly-formed mental habit in the childhood cannot be revised. Whatever they tries to improve them with preach, worship, praying, and lives of zen, it is hard to get accustomed to the right essentials of spirit by human forgetting. As human characteristics, however people obtain essentials of solution and good-will, most of them forget about them within one or two days or so, eventually they live up to comply with the existing habit. In the end, if someone constructs the framework of incorrect mental-habit, they had no choice but to face with their lives on the basis of tangled-up ideas and poor performances, so they may not succeed in and connect them with good results. It could not be a difficult process however inefficient their deep-rooted recognization and its own reflection, but be a commonplace stance with laziness when forgetting intervenes their behavior with the passage of time, since there is no suitable tools to correct its fatal problems. How the realization is performed within human forgetting, a certain person forgets most about something meaningful within the passages of from twenty minutes, if time passes two hours, since he or she only remembers something with the proportions of thirty percent, individually personalization programs are needed for people to maintains their own realization and self-reflection.

It is also needed to construct individually personalization management programs to focus on twenty-percent of a certain trial showing eighty percent of their own competitiveness. In this invention, the efficient methods will be provided in order to accordingly and effectively develop their own mental-habit & capacities. To enhance individual competitiveness and life-qualities in the near future, there are two curriculums including basic personalization development process of mental habit & competence, and advanced personalization development process of mental habit & competence to satisfy with specifically various needs. The advanced personalization development process of mental habit & competence applies the basic courses which mentioned above basically, and connects and utilizes it according to the specific purposes. The development course of mental capacity was invented in order to improve individual mental capacity effectively in the wired or wireless total convergence environment.

### The Definitions and Characteristics of Basic Personalization Development Process of Mental Habit & Competence.

There are two types of basic personalization development process of mental habit & competence including personalization development process of either the elevated value enhancing or the aggravated value diminishing. There are the following definition and characteristic of respective process.

First of all, the features of development factors of mental-habit capacity can be described with the seven conceptual figures including standard value, superior-above-standard value, inferior-below-standard value, elevated value, aggravated value, capacity value, and critical value. The standard value is defined as the relative conceptual value that expresses the individually existed mental-habit capacity, it is represented by a way of difference between superior-above-standard value and inferior-below-standard value, individually typical mental-habit capacity can be expressed as conceptual value of area that standard values of both Factor X and Y reaches. Elevated value and aggravated value is mentioned as the value of mental habit capacity that shows static change by certain causes, aggravated value can be mentioned as mental energy that changes the superior-above-standard value, and aggravated value is mentioned as the conceptual value that alters inferior-above-standard value. To enhance mental-habit & capacity, the capacity value should be go up with capacity difference, deriving from a phenomena that elevated value should be maintained higher than standard value, at the same time, aggravated value should be maintained lower than standard value. Additionally, the critical value is the mentioned as zero value that there is no difference between elevated value and the aggravated value.

Factor X is related with development factor that the entire mood and static change determines the long-term framework of its own, and since it affects the rest of two factors, the development factors of Factor Y, and Z should be deteriorated if the conditions of X development factors undergo bad. Moreover, since its undulation can be relatively changeable according to its own environment or stimulation, it is that factor that should be taken care of most delicately in a well-organized manner.

Since Factor Y is affected by the condition of Factor X directly, it has less static undulation than ups-and-downs of Factor X capacity value, in short, it is a gradually changing factors. Factor Z is influenced by the state of Factor X and Factor Y indirectly, even if the state of Factor X and Factor Y underwent unsuitable state, it has relatively low ups-and-down, unless it is not developed cooperatively in a well-organized manner on the stable basis of Factor X and Factor Y, it is not effective and cannot be maintained however it develops various Factor Z. Factor Z is related to knowledge capacity, therefore it is developed by a choice of two groups including personal tastes like interested-field, major, and hobby, and means of the need.

Elevated value and aggravated value of Factor X belongs to the value that reveals the static change by two causes including sentiments or health problems in the short-term, therefore if the elevated value of Factor X goes up, it is mentioned as the conceptions that increases superior-above-standard value and makes mental energy efficient including passion, desire, self-confidence, pleasure, and healthy state, meanwhile, if the aggravated value goes down, it is mentioned as the conceptions that decreases inferior-below-standard value and makes such mental energy distinct including thankfulness, humbleness, good sentiment, open minds-set.

Since elevated value and aggravated value of Factor Y demonstrates their own ups-and-downs by mostly the reason, rational thinking, logical thinking, action, and performance, if the elevated value of Factor Y goes up, it means that superior-above-standard value increases, action, performance, and concentration make mental energy strong, the aggravated value of Factor Y goes down, it means that inferior-below-standard value decreases, dimensional recognization, insightful vision, and wise choice make mental energy better and strong.

With consideration of human qualities, If the elevated value of Factor X goes up, naturally arrogance, and overweight desire arises from inner vision, eventually since the aggravated value of Factor X goes up, it will be required to construct methodological approach to make up of humbleness and open mind set with external support and reduced aggravated value. In addition, in case of minimization of the elevated value of annoyance, anger, and abandonment consciousness in consideration with human characteristics increases automatically, Such methodological approaches like either controlling the cause of increased elevated value or decreasing the aggravated value with external support, thereby constructing inner vision of humble and open mind-set. And if the elevated value is low, the aggravated value is high, and therefore the value reaches the critical value, it is possible to construct basis for returning naturally low elevated value back to the regular state.

When it is assumed that if the elevated value is much higher than superior-above-standard value and the aggravated value is high, and the capacity value of factor X identically have the value as A since the elevated value has as the similar value as superior-above-standard value or the aggravated value is so low, the aggravated value of X factor remaining low reveals a good condition in order to keep the capacity value more efficient, even with externally environmental stimulation. If a certain condition belongs to the state that critical value positions itself as high, it can make much undulation by stimulants or environment. therefore it can reaches the critical value more easily than it was expected. Therefore, it is important to maintain the aggravated value as low. In addition, if it goes over the critical value since it is not controlled well, it becomes the state of sentimentally overweight surplus, once it reaches such condition, it forms vicious circle of making sentimental explosion again even with a little stimulation, therefore, to manage the aggravated value stably and typically is more important than anything else. The critical value of Factor X reaches, since it is easy to leave big side effects, however capable he or she is, and eventually it is likely to have little choice but to face with fatal situation, it is important to control it delicately in a typical life.

The increase of the aggravated value of Factor X affects the increase of the aggravated value directly, and the aggravated value of Factor X becomes low, the aggravated value of Factor Y becomes low automatically. Therefore, since the trial to individually reduce only the aggravated value of Factor Y is ineffective compared to the quantitative amount of the trial, co-relation with the management of the aggravated value of Factor X can naturally reduces the aggravated value down. As a matter of fact, if in a mentally bad state individually, even if it seems that it is difficult to realize his or herself and control his or herself, the tangled-up problems will bo gone away if individually effective methods are mixed up with the following information utilization of this invention.

Main Topics for Conveying Information of Basic Personalization Development Process of Mental Habit & Competence.

In the basic personalization development process of mental habit & competence, the most important thing that comes first is the development process of reducing the aggravated value down. Since the aggravated value, which is mentioned as sensitive value that is depended on either incorrect mental habit or much stress that is possessed by him or her individually, it can make big undulation unwillingly by temporary causes of a short dream last night, trifling sentimental argument, only a word, and various experiences. For example, Although sleeping well and waking up, in case that the aggravated values remains high, it is commonplace that to solve this is difficult for him or her. Unless this problem is unravelled, life qualities or individual competitiveness can be affected negatively. In this case, the individual can solve this problem and start a day with good spirit if he or she is provided a contents focused on his or her personal taste-video or audio contents indirectly providing experience within the forms of controlling the sentiment well, such as TV short stories, or TV Exclamation Mark and minimizes the aggravated value easily. Therefore, if a person gets up, mental preparation process comes first than any other processes. Also, the process of increasing the elevated value should be done orderly from the previously decreased aggravated value to increasing the aggravated value gradually. The information utilization may not always be effective compared to its trial, if the aggravated value remains high. However high it may go up, it remains the conditions that makes overweight surplus of his or her stable life, it can affect negatively on the balanced thinking. Generally, the most dangerous cases are exemplified as follows: one can be the most acute problems for individual competitiveness if the elevated value keeps high, the aggravated value catch up with it, and it reaches the critical value—When the most desired work is messed up with overweight arrogance, and the other is can be also the problems if the elevated value keeps low, the aggravated value goes up, and it reaches the critical value—Failed, and frustrated, he or she messes up the work not controlling him or herself. In these states, it becomes the spiritual state that the capacity value of Factor Y and Z cannot be taken care of. So, Each time he or she faces with the worst work limited within the external environment, there can be the most dangerous results in individual's life.

A person experiences lethal failure or mistakes that a feat can be derided, as time passes, in this case, a person recognizes that he or she could not unravel the undoubtedly simple problems with over-fixation of incorrect habit. These mistakes can be repeated again mostly with similar reasons, so even if it is not corrected fully, the doom for him or her cannot be recovered.

personalization development process of diminishing the aggravated value can be provided as it shown below.

personalization development topics for diminishing the aggravated value of Factor X: thanking, being humble, not to be arrogant, being comfortable, making ope mind-set, making rooms for the rest of life.

personalization development topics for diminishing the aggravated value of Factor Y: diminishing bias, throwing the red-type away, making trial

personalization development process of enhancing the elevated value of Factor Y is provided as below.

personalization development topics for recovering self-passion

being self-confident, doing it on his or her own, challenging toward the target

personalization development topics for recovering self-strength

Recovering self-positive sentiment, finding own talents personalization development topics for health-management:

Recovering health in a personalization manner, Exercising in a personalization manner

personalization topics for developing pleasure and enjoyment:

Personally personalization humor, interest, and abundance.

personalization process for developing the capacity value enhancement of factor Y can be provided according to the following topics.

personalization process for developing the capacity value enhancement of factor Y can be provided according to the following topics.

personalization topics for right thinking and action: honesty, keeping the promise, keeping the rule, and keeping the plan straight.

personalization topics for performing wise thinking: Making wise choice, multi-dimensional reflection, concentration, endowing the priority from the most important to the least important, making creative ideas, preventing something unfortunate, learning form the failure, making economic mind-set.

personalization-made topics for keeping good human relationship: Making consideration, making lots of complimentary comments, satisfying with mutual benefit, having abundance and great humor.

The delivering process of basic mental habit & capacity development.

The delivery patterns for developing mental habit capacity on the personalization delivery basis which individually co-relates between on-line personalization delivery and off-line related personalization delivery can be divided into three parts including personalization delivery of recognization reinforcement, personalization delivery of daily action, and personalization sorting-up, therefore they are delivered toward the basis of personalization delivery through personal personalization menus and the basis of off-line personalization delivery.

Since personalization delivery of recognization reinforcement is mentioned as a kind of personalization delivery that is mainly oriented for personal development of mental habit & capacity, there are certain types of delivery patterns including the delivery of minimizing the aggravated value of factor X, the related delivery with both minimization of aggravated value and its enhancement of the elevated value among factor X, the delivery of decreasing the aggravated value that factor X and Y and accordingly mixed up with, the delivery of the aggravated value of factor Y, its correlated delivery of decreasing the aggravated value and increasing the elevated value, and finally a delivery of increasing the elevated value between factor X and Y.

And since personalization delivery for factor-to-factor decrease of the aggravated value and enhancement of the elevated value transmits personalization information related with the daily topics among personalization information newly documented according to the daily delivery topics and information saved in the self-control information, it can be widely utilized for enhancing mental capacity, using two delivered information in the delivery conditions.

Daily action personalization delivery can be either images or information which were summarized, in order to effectively perform personalization action management on the specific details of personalization delivery according to forgetting control and eighty-to-twenty law, connecting daily recognization reinforcement personalization information.

Daily finishing-up personalization delivery is mentioned as the delivery that provides recognization reinforcement personalization delivery in the end-up of evening, daily finishing-up concerned with daily recognization personalization delivery, revision on the daily basis, record management of performance levels.

With sorting mental habit & capacity of X and Y up, ready information for developing mental habit & capacity is defined as information that re-convey information which were related with daily delivered-information and managed to keep pace with personal personalization characteristics, managing some information that help to form the ideal mental habit among information mainly concerned with decreasing the aggravated value and increasing the elevated value, and controlling other information that were most desirably utilized or popular. If newly delivered information is not effective effect for him or her on the daily basis, it is allegedly mentioned that it is personalization delivery to enhance the development of mental habit & capacity, recycling information that were effective enough or popular in the past.

### The Definition and Characteristics of Advanced Personalization Development of Mental Habit & Capacity

Advanced personalization development process is mentioned as a suitable process that were planned in order to apply themes which were specialized for the purpose of application on the application basis and utilize them in various types of purposes. These are developed in the form of applied circumstances as it was mentioned below: studying field(studying attitude development, writing attitude development, studying skill enhancement, creative-thinking development, etc.), health-care field(basis of disease record basis, habitual disease management, personal health management, happy elderly life management, well-being food, well-being life care), financial skills(personalization financial engineering including real estate, finances, stock, etc), hobby and cultural life(off-line related core-contents, various hobbies, and cultural products developments including newspaper, and books), thrifty life and competitive life-information(local-oriented children education institution, medical institution information, law, administration, local community, information for thrifty household, and discounting information), prior-management related with mental habit in order to enhance personally specialized purpose(precautionary mind, planning mind, risk-taking management), on-site management(daily life performance, making choices), and post-event management(failure management, finishing-up, revision).

Advanced Personalization Development Process of Studying-Methods Related Mental-Habit Capacity

Advanced personalization development topics varies from purpose to purpose specifically, they are continued with various topics including forgetting management, eighty-to-twenty management-so-called Pareto Principle, reflexive recognization management, idea broadening, management on creative thinking, creativeness management. Forgetting management can be applied into the short term period after studying—from twenty minutes to two hours after learning is completed, also into the second forgetting about mid term period after studying which forgetting is completed about seventy percent—within two days. According to the separation of personally studying-related personalization code, they are delivered in the form of personalization application, creating the basis of closely personalization support and total convergence network. The patterns are applied according to the purpose of the following specific process.

Specific Process 1: According to personalization code of personally studying-related ready made code, various types of personalization assignments can be delivered regularly into the form of personalization representation methods, therefore this process can be supported with prior consideration, forgetting management, and reflexive insight broadening.

Specific Process 2: It is mentioned as a process that on the following contents of either on-line or off-line learning, specific details of studying patterns provided with personally learning-related personalization code basis given by the topics of main studying contents, questions, reflexive recognization, thinking differently, and creating ideas should be submitted on-line or taken the images by mobile phone and hand them in after documenting off-line studying details,

Specific process 3: This process is mentioned as a certified process that co-relates with personalization information according to personal taste, when studying the contents of textbooks with utilization of off-line coherent code included in the off-line textbook that related with the personally given classes.

Specific 4: It is mentioned as the feedback process that within two days of specific 2 process, self-documented file as the second forgetting management and superior data of his or her friend, and teacher's comment can be provided according to individual personalization code, therefore, submitted specific details can be reanalyzed, verified with new perspective, and provided according to personal taste, thereby performing comparison with other ideas, which had been designed in order to obtain effective learning-benefits including thinking differently, broadening insight, multi-dimensional reflection, learning.

Based on this process, these can be utilized on the advanced personalization development.

### Personalization Development of Factor Z Capacity

On-line personalization delivery and off-line personalization delivery can be performed, setting-up the personalization field in the various personalization menus on related fields of factor Z including education, shopping, finances, insurance, broadcasting, radio, financial skills, life information, hobby, and major with no charge or charge.

For example, it is defined as miscellaneous classification systems which had been sorted through large, medium, small, detailed, and micro, information classification systems can be set-up with various information classification codes in the form which enterpriser suggests with simple configuration located within personalization menu: big item(education, financial skills, health care, shopping, information, and hobby), medium item(children education, stock exchange, exercise, clothing, news, Go), and small item(writing essay, stable-operated fund, bicycle, luxury items, intermediate Go).

### The Second Personalization Methods Through Personal Information Utilization Career and Application-Response Evaluation

It is necessary to supervise and control the second personalization characteristics that the most desirably-utilized personalization information among personally delivered personalization information according to personal taste should be supervised, recognizing the personal level of information utilization.

personalization index can be created and supplemented according to personalization field, after specifically analyzing its own utilization career or response of delivered personalization information and performing the second personalization action toward them.

Regularly, the second personalization index can be reflected as personalization code of the priority application of personalization information delivery included in the personalization menu.

For example, the second personalization action can be evaluated through apparent application response with following steps including the first step that checks the contents with overall view of title created with the headlines & topic pattern, the second step that in mobile phone, moves in its related pages and make a utilization of them, the thirdly advanced step that checks its related contents through web-sites which were co-related with other mediums like PC or IPTV in order to verify the detailed-contents of related personalization information, and the last step that verification such as headline topic located within mobile-phone waiting screen is not performed.

In addition, if a certain person input response intensity according to the provided form of application-response, the second personalization characteristics can be known by endowing mileage or points.

### The Personally Recommended Methods of Information Connection Limitation

Premium information that parents are most desired for children can be delivered in the total convergence networks on the personally personalization basis, therefore various connecting-limitation methods can be provided with set-up basis of various personalization code so as to endow their valuable availabilities and limit side-effects of the previous internet information utilization.

As a total delivery scheduler, mobile phone enables the wired-internet connect cooperatively with mobile phone, and limit co-related pages or sites in order to be used within the indicated time. Throughout direct internet connection toward PC or IPTV, the approach can be limited through password-input.

Additionally, the available environment to utilize information with personally-intended methods can be provided with personally personalization menu provision system that can lead people to design and seek for meaningful life, not to get accustomed to the page organization of top-down methods that previous time-killing and sensational—information would be drawn by user.

This system is mentioned as the available system that the environment to provide information untouchable by children, information utilization environment that regulates his or own addiction, and information utilization environment to limit non-purpose information utilization that cannot be competitive for life quality can be provided.

personalization code configuration such as the most favorable relationship, setting-up prohibition, limitation, mainly-utilized terminal configuration, mainly-utilized place configuration, and making a choice of subject that should be necessarily delivered.

For example, information utilization through PC or IPTV can be utilized in a ready-manner according to personalization information given by co-related delivery through waiting screen, choosing beneficial information products(education, health-care, and hobby) as personalization menu and utilizing personalization information basis(individually-chosen information that were beneficial for parents and children), and if a user makes a utilization directly through PC or IPTV, they can be only used in the personalization limited environment provided according to the personalization characteristics

Methods to Perform Co-Related Delivery and Reserved Delivery into the Other Terminal

In this invention, co-relation functions between terminals are provided in order to enhance utilization with personalization utilization methods according to personally information utilization circumstances, separating one information utilization suitable for mobile phone window and the other information utilization suitable for PC and TV.

Co-related delivery or served delivery can be utilized, using the other terminal or mainly-applied terminal which were set up for the mainly-utilized places.

In this contrivance, two co-related methods can be used with on-line co-related code and off-line co-related code.

First of all, this step is mentioned as the co-relating methods that on the basis of MAC addresses toward all of terminals, related-codes are indicated in the respective site within monitors of terminals, and co-relate them attached to the terminal with code-recognization basis, after taking images of mobile phone camera

In addition, After making configuration of the mainly-utilized places and terminals that can be cooperatively utilized in them, when a certain person is located in the main utilization place, and co-related or reserved delivery could be utilized with demand input of available mainly-utilized terminal, and if chosen with most-desirably wanted terminals, then also co-related or reserved delivery are available, too.

The configuration of the mainly-utilized place and terminal can be set up in the process of cooperative registration of MAC addresses of terminal positioned in the following mainly utilized place on the basis of wireless transmitter's MAC address and location verification.

In addition, if the most-desired terminal is set-up after choosing the most wanted one of the mainly-utilized terminal list that can be used in mainly-utilized places and reserved-delivering key or demand are input, reserved facts were notified for user and a suitable delivery environment is provided in the reserved delivery terminal.

For example, in terms of configuration of mainly-utilized place and terminal on the basis wireless LAN network, if a user register the mainly-utilized place in the wireless LAN network of his or her mainly-utilized place with wireless LAN dual mobile phone, the following device-separated address(MAC address) of wireless LAN can be recognized and registered, and finally used as recognizing key for separating the mainly-utilized place.

Additionally, the mainly-utilized terminal co-relates with the mainly-utilized terminal, MAC addresses are registered and controlled if taking images of cooperating codes indicated in the site of internal monitor positioned in the mainly-utilized terminal are performed.

Moreover, on the basis of wireless internet network, the mainly-utilized places are separated from either basis of base-station communicating range or GPS basis, the mainly-utilized terminal can be controlled, and MAC address of the following terminal can be supervised as a distinguisher of the mainly-utilized terminal management if the mainly-utilized terminal set up co-related codes which were indicated in the specific site of the mainly-utilized terminal as a camera.

The co-relating code with method application of this invention can be reutilized within the range separating from mainly-utilized places, a simple system can be constructed, not using different co-relating code according to the respective terminal and position.

The Methods to Maximize Free-of-Charge Environment of Wireless Lan Network

In the present, LAN network can be divided into various networks including one wireless LAN network that a certain enterpriser utilizes as membership basis, and the other network that can be utilized as membership registration in the company or school, and another network that can be utilized with registration of home or family.

Mostly, these can be used either with the prior registration of local officer automatically or with data registration basis of user distinguishing datum. In this invention, co-relating the environment that various customers have used with environment suggested by the contrivance, they are used according to the personalization menu designated by personally utilized places, and entering into the particular space including apartment complex, store complex, subway, or public place, personalization advertisement can be included in ready-menu which personal tastes were reflected with conditions of free-of charge utilization of wireless LAN networks.

It is allegedly mentioned that it should be the basic structure to keep networks stable with personalization advertising benefit of management costs of wireless LAN network installed in the indicated place, swift access to utilize wireless LAN with free-of-charge way can be broadened. A enterpriser installing hot-spot according to various particular places can extend his or her own hot-spot in various types of patterns, providing advertisement for promoting his or her own stores, receiving regular profit benefited from the personalization advertisement with installment condition

Methods to be Profitable for Site-Connection on the Basis of Personal Personalization Features

1. It is the certified methods that with the certain conditions of delivering information for customers that are accordance with their products, information provider obtains a commission. Since information provider can deliver them after selecting most-likely desired customers toward his or her products, it is expected to achieve positive effects such as simpleness and swiftness of developing products and selling them, and cost-effective impact of marketing cost minimization except for net costs needed to develop products.

2. It is allegedly mentioned that the according to the standard of user utilization response, commission system toward the following personalization information in the process of personalization delivery can be applied discriminatively from the certified information provider. Discriminating rates of fee payment according to the following levels are done, including utilization levels checking transmitted-information in the headline pattern of cell-phone, utilization levels checking reservation or co-related delivery in PC, and utilization level that buying-out or transactions is connected through the following user information, additionally, sorts of commission benefits can be provided toward responsive information provider.

3. It is allegedly mentioned that this methods enables to make profitability from commission with discrimination between utilization levels being connected through purchase or transactions and one utilization level which user verifies, toward explored information or site being provided as the basis of personally personalization information among this invention, except for conception that it is a surfing information providing system which creates with the pattern of site-oriented ranking indication, and focuses on enterpriser promotions such as the existing overture in key-word exploration process through either mobile phone or other terminal.

### Differentiated Product-Marketing Methods on the Basis of Total Convergence and Personal Personalization Bases.

Reviewing a number of the most-recent future trend information, various information and products including desire satisfaction, mental satisfaction, economical satisfaction, habitual satisfaction should be provided in order to satisfy variety of needs. Since the desire trend of customer has been varied and the competition of enterpriser have been extremely scarce, information provider have strived to establish various differentiated-tools for extending demand, customer contact point, and loyal customers. Since most of enterprisers hold responsibility of businesses in the specified forms of various sectors, they have tendency to be more biased or deficient information to comprehend all of personalization information. In this invention, with total convergence business area, various differentiated-marketing methods can be contrived with methods to establish widely broadened personalization information.

The personalization information provided by this invention can be organized into two types. Provided as two types including on-line and off-line, they are organized into two types including information-related personalization information of factor X, Y, and Z, and various product-related personalization information. The classification of products are organized into on-line convergence product, off-line convergence product, on-line and off-line co-related convergence products, and the classification of products are done according to the utilization patterns such as steadily-maintained products, short-term maintained product, except for these, there are additional types of some products that marketing competition is heated, and other products that it is heated barely enough.

On-line convergence products can be described with examples of products mixed-with on-line service product and commercial product, Off line convergence products can be also described with examples of products mixed up with off-line education service product and insurance service product.

Convergence products co-related with on-line and off-line can be organized as the following examples are described. For example, various benefits including differentiated insurance-related products, hobby-education field, health-care related field, finance-related filed can be provided on the basis of mental capacity development with support of programs in order to maintain their own happy life and health whenever they are needed: the existing learning education including various subjects, English, and writing essay, related products concerned with Factor X, and Y development-oriented on-line program, mental-habit development on-line product related with office-worker discipline training education and employee competitiveness enhancement, related product for office-worker demand and its family's demand, various insurances straight life insurance, and health insurance.

The steadily-maintained products are mentioned as the products that were maintained to utilize for more than certified periods only with one-membership with telecommunication service product, insurance product, education service product, and financial product, while the short-term maintained products are mentioned as products that purchased-places can be altered and utilized with utilization of shopping, gas-lubrication, traveling, leisure, and food-restaurant.

Convergence-provided patterns are divided into convergence between steadily-maintained products, convergence between short-term maintained products, convergence between steadily-maintained product and short-term maintained product, and convergence pattern between information and product.

Competition-heated products are organized into credit card, insurance, finances, and telecommunication, and meanwhile, education products belongs to mediated-competition products

Discounted Marketing-Methods on the Basis of Total Convergence and Individually Personalization Bases

There are two types: listed-price discounted marketing and discounted marketing through membership discounting coupon-providing. Listed-price discounted marketing is mentioned as the behaviour that provides direct listed-price discount according to the product package organization, moreover, discounted marketing through membership discounting coupon-providing is defined as discounted-marketing that provides various things including individual life-cycle, economic environment after incorporating various discounted-marketing in a personalization manner. And membership discounted marketing can be organized into two, one is the discounted-marketing that a person can choose among the ratings of personalization codes given by the first contrived service, meanwhile, the other is the discounted-marketing that pays the amount of money in the discounted marketing of rated-membership endowed by available membership discounted-marketing and utilization levels. Taking examples which membership discounted-marketing can be applied, it specializes various fields including hotel, condominium, restaurant, club, on-line product, leisure, and shopping into separating fields including classification of the number of uses, time allocation, classification of days, separation of sector-to-sector field, fee separation, generation separation. Commonly, straight-life member and providing this membership by the unit of year can be chosen in a personalization manner with diversification of monthly, quarterly, timely period separation. In the case of paying the certain amount of money and performing discounted marketing, monthly membership-payment can be diversely provided from thousands of won to hundred of thousands of won with various discounted-marketing convergence methods.

### Convergence Benefit Offer Marketing Method on the Basis of Total Convergence and Personally Personalization Bases

Benefit offer methods should be desirably contrived including various differentiated-mileage mixing-up with the existing mileage offer marketing. With utilization of the presently-held mileage incorporation, and uses of products that enterprisers indicated, this method is defined as methods that various benefits can be provided on the basis of personally personalization bases after adapting various methods to supplementary mileage provision, total product utilization, personalization information and advertisement utilization, personalization code configuration, and answer to utilized-response. Such benefits enables to co-utilize or endow some of parts to the most-friendly and related party.

1. If user signs up for service membership, not using this contrived personalization portal service, the method should be mentioned that a person should be given mileage or benefits in case that service provider signs up for steadily-maintained products indicated by service-provider and utilizes them
2. If the user, who hasn't used this contrived personalization portal service, signs up for membership and has utilized the steadily-maintained products that service provider indicates, this method is mentioned that the user additionally uses other products that enterprisers have indicated within justified periods, and the utilization levels that enterprisers indicated reaches the justified period, either mileage or some benefits should be provided.
3. It is mentioned as a way that both mileage and benefits can be discriminatively provided in case that the user additionally utilizes products that were specified under the personalization codes of user utilization level, or in the case that the user obtains benefits or mileage according to the utilization level that supplemented personalization advertisement, personalization information, and response toward utilization responsive degree.
4. It is defined as a way that an enterpriser endows the respective proportion of mileage for recommender additionally that membership-subjective obtains it later, since the recommender make customer that utilizes the products indicated by the enterpriser sign up for the contrived service.

The Discriminative Providing-Methods According to Product-Provider Ratings in the Personalization Information Offer

In this contrivance, in the inner extent, it is mentioned as not small-marketing concept that endows bit of mileage with the perspective of additional-utilization motivation like the present mileage marketing, but application of marketing methods including seesawing-marketing and inclosing-net marketing, incorporating and grouping among steadily-maintained products as main expenditure of home including insurance and education, the short-term maintained product, on-line and off-line, information and products.

Taking examples of seesawing marketing, according to the expenditure levels of monthly insurance expenditure that the present mileage has not been endowed, mileage is given according to the monthly payment toward steadily-maintained products, and additionally, if the steadily-maintained products that are provided by this service were held by users, and the short-term maintained products are provided by users, lots of mileage is additionally provided by users, therefore, it should be mentioned as the marketing pattern that enhances utilization rates of short-term maintained products indicated by the enterpriser, thereby increasing the marketing effect among different grouping-products.

In-closing-net marketing constructs the available standards of products keeping pace with premium products according to sector-to-sector position, organizes some of enterprisers that provides the present personalization products that most-likely included the performing range of user personalization characteristics, and is mentioned as the marketing methods that user's choice can be positioned within enterpriser ranges of this service-providing.

According to this contrivance, this methods provides more differential benefit than the priority-applied grade of basic personalization information delivery, and increases the entire marketing booming-up of service-products of this contrivance. For example, toward personally-specialized product choice, and a certain user that is accordance with specified product choice, and specialized personalization code, and specialized utilization ratings, It is mentioned as differential methods that they are should be delivered discriminatively with higher priorities than those of any other product provider.

The organization and controlling-system of various personalization code.

The certain types of personalization code are classified into personalization code specializing in personal basic information, personalization product, personalization information, on-line and off-line co-related code for co-relating on-off line incorporation, product-classification personalization code for allocating products, and information-allocating personalization code for classifying information-allocation. Various personalization codes can be provided with on-line code book indicated in the monitor that facilitates personalization configuration, and in the form of menu patterns or off-line code books such as newspaper, and books.

Various codes typically utilizes separated symbols such as number, and characters in order to facilitate the personally personalization characteristics according to the specific fields, and operates and supervises system by means of personally-managed system. product-allocation personalization code is mentioned as certain types of codes that personalization information providing enterpriser sells, marketing-agency is performed, and total mileage can be applied.

Information classification personalization code is mentioned as personalization code in order to classify information that can be utilized for personally personalization delivery. In person, personalization characteristics is controlled as the first personalization characteristics data according to both personalization characteristics separation and levels recognized by code-configuration, and they are controlled as the second personalization features that separation or grades were specialized as personalization utilization career and utilization reflexive intensity.

The Organization of Personalization Menu

In terms of personalization menu, there are various on-line personalization menus and off-line personalization menus for off-line co-related delivery.

In terms of the organization of on-line ready-menu, specific personalization menus can be organized as place-to-place ready made menus, where various grouping and menu-creation according to specific personalization field were performed. Personalization information in its specific personalization menu can be provided according to specialized field and the set-up contents with the top priority. Personalization information can be daily delivered according to the delivery priority ranking configuration of personalization field, and specific fields which the top priority has been guaranteed is delivered on the daily basis, while, in terms of specific fields which the bottom priority, they are delivered once a week. In addition, delivery priority ranking according to the customer-to-customer stance can be regulated on the regular basis, with clear standards of the delivery priority ranking reflected by utilization response of personalization information. Personalization menu can be set up individually by detailed personalization menu organization, meanwhile, the certified types of specific personalization menus can be existed diversely with product personalization menu, information personalization menu, free-of-charge information personalization menu. Also, specific personalization menus can be utilized through either types including pop-up activation and non-activation of pop-up. For the creation of convenient personalization menus, they can be configurated easily by personalization menu code designed for simple setting-up. The places for utilization can be divided into the mainly-utilized place(home, office, and school), commuting-line place(subway, and crosswalk), particular places(department store, store complex, and complex place), and can be designed enough according to the personal purpose and habitual utilization.

Moreover, additional personalization menu according to separation between wireless internet network on the basis of mobile network and wireless LAN network, and between PC and IPTV, can be utilized and constituted. The following personalization information according to the personalization sector-to-sector in the detailed personalization menus should be applied and provided by means of the following processes. First of all, scheduler processing personalization information according to the personalization sector of the detailed personalization menu can be provided with the priority ranking, whenever a certain user utilizes on-line personalization information, provide information specifically from the highly-related to the least related, with reflexive-degree calculations of personally-specialized personalization code toward the personalization information(a sort of information that personalization index was endowed and provided for each information) located in personalization information pool. Reflexive degree is calculated with priority-ranking application when calculating reflexive-degree which was related with the following information delivery. This arithmetic calculations can be performed and provided when the following specific personalization menu information is reorganized.

Off-line personalization menu is provided with inclusion of newspaper and books, it co-relates and utilizes with on-line media, taking camera images of off-line co-relating code included in personalization menu and inputting them. In this case, in the reflexive-calculation of personalization feature index and personally-related code feature index toward personalization information positioned in personalization information pool which plays vital role as co-relating code, only information which indicates the top priority can be provided in a personalization manner. As personalization menus including newspaper personalization menu, book personalization menu, insurance-designation personalization menu, education-planning personalization menu, financial-planning personalization menu, shopping personalization menu, hobby & education personalization menu, and discounted marketing personalization menu, they enables to facilitate off-line product registration and perform information utilization. In off-line co-relating code located within off-line personalization menu, personally personalization information can be provided according to the personal taste.

Personalization Code System

Personalization code is mentioned as a configurated code to manage personal personalization characteristics on the total convergence basis of this contrivance. Personalization code can set them up by itself with utilization of code book, and it set them up in details, performing close investigation and checking them up in details on the basis of consulting service done by professional sector-to-sector specialist.

In addition, simply-configurated codes are provided in order to consider the most-favorable personalization characteristics, create and incorporate similarly grouped-packages, and simply configurate them in a personalization manner. When personally-chosen personalization codes and simply configurated range are mixed up with, personally-configurated personalization code can be managed with the personalization priority ranking.
Personalization code for generation: It is generally mentioned as personalization code that discriminates generation classification in order to develop personalization information with separation of sex, age, and etc. and supervise configurated matters conveniently. It is allegedly mentioned that it strives to specify various types of generation into infants, below third-grader in elementary school, above fourth-grader in elementary school, middle-school students, high-school students, university students, employees in offices, employees from twenties to thirties, employees from forties to fifties, housewives from twenties to thirties, housewives from forties to fifties, people who are more than sixty.
Personalization code for character: It is allegedly mentioned that this code seeks to separate character by its results of blood type, four traditional physical constitution, and the results of character & type check-up. There are one way that a person configurate codes and the other way that results of specific verification performed by the public configuration can be reflected and set-up with results of them.
Personalization code for developing Factor X and Y: It is mentioned as a specific personalization features that focuses on the directions such as (individual competitiveness, homage-education competitiveness, human sensibility development, and performance development). The following separation can be performed with factor X oriented, factor Y oriented, factor-X-oriented for decreasing the aggravated value of factor X, factor-Y-oriented for decreasing the aggravated value of factor Y, the elevated value increase-oriented for factor X passion and strength-concentration, the elevated value increase-oriented for factor X health and enjoyable pleasure topics, the elevated value increase-oriented for performing right-thinking of factor Y, the elevated value increase-oriented for performing wise-thinking of factor Y, the elevated value increase-oriented for forming human-relationship of factor Y, and service-provider recommendation-oriented. If a person set up these personalization codes, personalization recommendation should be performed after adapting to the other personalization codes. The suitable insight of providing personalization information, personalization information of topics lied at the core of topics is reinforced and provided more severely than any other development information in the case that the entire development topics regarded with factor X and factor Y are provided. Information-delivery-rate on main topics takes up by forty percent, the other topics takes up by twenty percent, and various information weight toward core topic are provided in personalization manner.
Personalization code for developing suitable learning attitude: It is mentioned as personalization code that specializes personalization products and learning-attitude development direction in a personalization manner. The following separation toward self-confidence enforcement, self-performance, doing first from the most important to the least important, enforcement of concentration, enforcement of performance, and interest motivation should be configurated. If a person doesn't set the following code up, a certain person should adapt to the other personalization code and recommend the code in a personalization manner. The suitable direction of personalization information, on the basis that the entire development topics toward learning attitude development should be provided, can be more enforced and provided than any other developed information. Miscellaneously organizing the delivering proportions of core-topics and other topics according to the following code-configuration circumstances.
Personalization code for learning-methods: As levels of reflexive recognization, understanding, memory, logical power, concentration, creative thinking, and advanced thinking varies from children to children, it is mentioned as the code that specializes the standards of factors and the most effective learning-methods should be given personally among five factors. Separating the respective factors from the superior to the inferior, or from the first level to the fifth level, the most adaptable methods to provided program should be specialized according to the personal taste and provided enough. The following methods given by the personalization program can be applied, utilizing the factors including forgetting management against the certified periods including twenty minutes after studying, two hours after studying, and two days after studying, the priority management by eighty-to-twenty principle—so-called as Pareto Principle, management of other person's thinking on the basis of wireless internet network, management within advanced personalization development process of related studying-methods.

For example, education processes can be given in a personalization manner according to the level of understanding, the level of calmness or urgentness, the level of remembrance, and the level of creativeness. Utilized degree can be also enhanced with the level of summary and sorting-up, step-by-step studying, looping studying, reading the other's, management on incorrect questions or mistake, broadening his or her idea given by children characteristics.
Personalization code for health-care: this methods seek to from the most adaptable health-management habit among genetic environment, habitual environment, and home environment toward physical constitution separation such as four traditional physical constitution separation, blood types, family disease career, genetic and innate disease career, usual habit, exercising habit, eating habit, mental habit.

In the past, health-management should be performed by his or her goodwill and information, while according to this contrivance, personalization application toward various programs being mixed up with prior recognization, personalization information, post-management, close-management for twenty-four hours can be performed in a personalization manner, thereby enhancing the expected effect.

The following two programs can be provided: the configuration of one program through its code-book should be done automatically and provided, and the detailed programs can be provided after close analysis through check-up of professional experts. Utilizing the first basic personalization management factors including four traditional physical constitution, blood type, and classification of physical test, disease career management including disease career or genetic disease career, habit personalization management factors on habitual process including disease-career management factor, eating habit, and life habit, exercising habit, health-related mental habit, specialization according to the personal taste is performed among various programs. they are directly controlled according to the basic mental-capacity development process in order to not only provide personalization information and but also perform them, with various patterns of health personalization information, various and specifically-designed exercising programs, and mixing up with health care program.
Personalization code for the inveterate disease: It is specifically designed code to intensively care for inveterate diseases including hypertension, diabetics, cancer, and asthma, or habitual disease including smoking, addiction to drugs, and obesity. If the treatment is performed by doctor's comment, the remedial effects can vary from personal taste to the surroundings, however, by this contrivance, personalization management is done with medical expert's care including prior management, close management channel for twenty-four hours, and management methods, and recognization methods, therefore effective and convenient management can be done with diversified personalization management, and the concept of attending physician and personal secretary on the basis of professional consulting.

The management classification factors separates various factors into four including inveterate disease management factor, habitual management factors including eating habit, life habit, exercising habit, health-related mental habit, treatment personalization management factor that personalization manner can be chosen among various treatment programs, life-management personalization factors that closely manages the following disease mainly connecting fitness training, massage, and yoga. Therefore, it strives to comprehend and incorporate these various factors to enhance the effect.
Personalization code for religion: It is defined as the code that specializes the applied levels of religion in the provision of personalization information. In the process of providing information, separation from various religion and the providing levels of religious information are separated in personalization manner. religion separation and levels of religious inclusion are separated and provided after separating the level from the upper to the lower.
Personalization code on levels of personal taste: it is mentioned as the specific codes that specializes utilization tendency levels of steadily-maintained products according to the personally classified product personalization code or utilization tendency levels of the short-term maintained products, tendency levels of charged personalization information utilization, tendency levels of free-of-charge personalization information utilization, tendency levels of advertisement utilization, tendency levels of shopping, tendency levels of education, the tendency levels of marketing utilization, and tendency levels of mileage utilization. There are two types of processes including the first personalization through code configuration, and the other personalization level that share personalization information about the utilization experiences of products and information among information providers.

In terms of tendency level and education-tendency level about products and charged personalization information, it chooses the highly related specification, and applies the priority ranking level into the separating factors among allocations including popularity-oriented, character & self-characteristics-oriented, luxury & luxurious item oriented, rational choice oriented for economy and efficiency economic consideration-oriented, creativity-oriented, interest and pleasure-oriented.

In terms of tendency levels of free-of-charge personalization information such as news, this levels can devide the level discrimination of concerned-information into some parts from sacred state, safe and enjoyable state, and valuable state to pleasure, popularity, and sensationally-oriented state. Personally managing interest levels of actual information adaptability and specifically set-up interest levels, set-up interest and utilization interest can be managed to draw into the interest that he or she directly configurated for him or herself, and notify the differently-changing circumstances and support a certain person into the direction that a certain person really strives to do.

Tendency level of advertisement utilization chooses some discriminating factors and applies the priority levels into the separating factors including show-hosting pattern with detailed contents with separation of contents, interesting and creative advertisement patterns such as UCC videos, On-line shopping advertisement patterns, On-line shopping advertisement pattern, advertisement patterns with on-line shopping. Shopping tendency levels chooses high separation and labeling them as luxury and luxurious item-oriented, value-purchase oriented, economically-oriented, big discounted-price-oriented, chooses the separating factors, and apply the top priority levels after selecting some separation.

Separating marketing tendency levels and mileage tendency levels into generations, personally-favorable marketing field or mileage fields can be labeled or the top priority ranking can be applied into leisure, restaurant, hotel, traveling, shopping, on-line products, telecommunication products, insurances, finances, educations, financial-skills, healthcare, and hobby.
Personalization code for user level: According to the user level evaluation standard to be suitable for the following fields on utilization periods, utilization sides, and utilization characteristics about tendency-level factors of information-classification personalization code or product classification personalization code, the enterpriser performs specialization of the labeling of levels, sharing personalization information among information providers and adapting to the following utilization levels including the utilization level of personalization product, the utilization level of personalization information, the utilization level of personalization information, advertisement utilization level, shopping utilization level, education utilization level, marketing utilization level, and mileage utilization level.

Various utilization levels can be separated with generation levels or the top priority ranking-grades can also be applied. For example, Applying the overweight average with the past utilization records according to the respective evaluation fields, or evaluating with the recent three-month utilization records can be done diversely.
Personalization code for personalization information field: personalization information fields can be set-up according to the detailed personalization menu between on-line and off-line. There are various types of menus including place personalization menu, saving-bases personalization menu, off-line personalization menu, wireless LAN network and ready menu of wireless internet network, personalization menu of PC and IPTV. Through personal code-designation, the first personalization configuration can be done, and the enterpriser performs the second personalization configuration, sharing utilization records, utilization responses, and personalization information.
Personalization code for the delivery priority levels: It is mentioned as a code that the user should configurate the detailed personalization menu about the personalization menu, and configurate closely about the priority ranking for delivering information. The suitable priority can be designed, for example, the detailed personalization menu and personalization field can be delivered everyday, for a couple of days, and for a couple of weeks. And, the enterpriser evaluates the utilization records and responses of ready made information transmitted by the priority ranking list, regulate and reflect the priority ranking in the case that utilization responses are better. Taking an example that reflects personal utilization responses toward the priority list, through the following stages, the utilization responses can be also evaluated, for the first of all, it is the mentioned process that verifies the title in the form of head line and contents on the mobile phone waiting-screen service. The next step is that verifies the related contents more closely than before, thereby co-relating other medias including PC or IPTV, and the final step is that even head line topics are not verified on the waiting screen of mobile phone.
Personalization code for the number of delivery: it set-up the number of personalization delivery, and easily set-up with separation the number of delivery.
Personalization code for the most-favorable relationship: It is allegedly mentioned that between parents and children, between husband and wives with the basis for the most-favorable relationship, personalization code configuration & management, mileage incorporated user configuration, financial management and creditable transaction, sensibility management in their own lives, and configuration of supporting-direction that were designed to support for competitiveness management and set-up the related party. For example, if the parents make children not configurate the specific field in the process of personalization configuration of their parents, and configurate the limitation of fee through setting-up. In addition, it could be configurated for the old parents who are not suitable for internet utilization to configurate and make approval. In order to buffer mental problems and crisis broken up by daily lives of the most favorable party, the party can support for personalization information utilization as daily special support program.
Personalization code for prohibiting configuration: It is mentioned as a certain code that configurate codes with the purpose of prohibiting configuration of the designated code in the process of code-configuration of the most favorable party. Wanted information among personalization menus can also be designed to prohibit the configuration. It could also prohibit the configuration about contents that are not safe, not competitive, and not helpful for children. Even if children have already configurated about this cord, the presently configurated field was except for range of the configuration. Not delicately configurating them, personalization code with simple configuration can be set-up, provided by information provider.
Personalization code for limitation confinement: It is mentioned as a code that configurate various things including limitation confinement of daily or monthly allowed amount after approval, usage limitation of fee, purchase limitation, code-configuration limitation, limitation on additional connection of personalization web pages, limitation on information utilization time-limit, in order to limit the usage range according to the business environment. Not delicately configurating, the information provider can also configurate personalization code with simple inclusion.
Personalization code for the mainly utilized terminal: The mainly utilized terminal is mentioned as the most utilized personal terminal positioned itself in the places including home, offices, and school. Personally configurating the mainly utilized terminal, these chords enable to co-relate with wired & wireless devices comfortably and configurate them. For example, The methods to individually register for the mainly utilized terminal is that a user input MAC addresses of individual terminal through the Internet, or the system of enterpriser reads the registration system automatically, then messages can be transmitted via user's mobile phone from registration system, registered terminal enrolled in the present places give an answer to whether the mainly utilized terminal is in that place, and then finally it cooperatively registers both the mainly utilized place and mainly utilized terminals. In the mainly utilized places, MAC addresses supporting for the wireless internet can be also mutually controlled, registered, and processed. The co-relation methods of the mainly utilized terminal automatically co-relates the mainly utilized terminal, provides lists of terminal, and indicate the most desired co-relation devices on the location check-up basis of wireless internet network or wireless LAN network.
Personalization code for the mainly utilized place: It is mentioned as the codes that configurate places such as the collective information utilization places like home, or offices, configurating factors can discriminate places as a discriminating factors of related devices with MAC address, or device ID, also it utilizes the discriminating factors of related location with the GPS basis in terms of the extra wireless internet network. In terms of usage, it is used to facilitate terminal relation after using related-code between the two parties, taking an example, if the other party comes to the mainly utilized places, and wants to co-relate and utilize with PC or IPTV, the configuration is finished with taking images of terminal co-relation code, and input of mobile phone number is finished, the other party can co-relate with the following terminal and can utilize all of information. Therefore, if the mainly utilized terminal is set-up, it might be utilized as a factor that discriminating the following locations and respective places.
Personalization code for urgent delivering subject: It is defined as personalization codes that it performs the labeling of levels according to the priority grades list and pop-up with the certified period basis toward the certain subjective personally indicated as a delivering information in the form of personal notification such as main, and message, in order to support personal management.
   The urgent delivering subject ranking lists can be realized through managing phone number and E-mail address of the most-wanted subjective and urgently delivering messages, performing urgent delivery within the system that function to urgently indicate messages in either E-mail or message system, and performing urgent delivery whenever urgent situations are broken out and it should be notified to the various parties in a number of sites. The specifically indicated-details are organized into two parts including urgent delivering subject list configuration and the site configuration of urgent transmitted-information acceptance.

### Personally Personalization Input & Output System

Since there should be an easily accustomed input & output devices for users, input & output utilization methods are invented and applied, in order to transit the present methods into individually personalization methods toward various input & out methods including off-line media utilization like mobile phone input&output, PC input & output, IPTV input & output, utilization of the existing off-line media such as newspaper or book.

First of all, In code input, printing indication basis including bar-code, colour code, and image-code and personalization code of meta-data factor X, Y, and Z which monitor-indication basis code patterns were utilized can be co-related with code-configuration with utilization of on-line code configuration in the code-zip of on-line and off-line or the other utilization of taking images in the mobile phone, therefore personally personalization code can be wet up. Co-relating the mainly utilized terminal as a location basis with terminals input and output from the mainly utilized places, the code configuration can be cooperatively either input or output. Likewise, input of information can be cooperatively related with the synonymous concept. In addition, separation terminal which can group types of terminal from MAC ID enables to cooperatively input with personalization code as a configuration information.

A customer must endow the configuration function, and sign up for the portal on the free-of-charge basis if the party desires to use the personalization code configuration service. personalization code configuration set code patterns which were shown on the various code book up. In the code book, specific details are provided according to the personalization codes, therefore a customer can utilize them conveniently.

For example, if personalization code configuration procedures are explained, keys or commands could be input on the mobile phone, therefore, by camera attached to the mobile phone, acquiring one or majority of existing code patterns of configurated code with input of function key and demands.

In personalization code configuration service methods utilizing personalization code configuration of u-personalization personalized service performed by this invention,

configurating various personalization code(S100); personalization code configuration services methods that focuses on including the steps(s200) verifying configurated results from the personalization code configuration & management system department.
In the following step(S100), it is mentioned as personalization code configuration service methods characterized as performing configuration with on-line code book when configurating personalization code
In the following step(S100), it is mentioned as personalization code configuration service methods characterized as when configurating personalization code
In the following step(S100), it is mentioned as personalization code configuration service methods characterized as acquiring code pattern from off-line code book using the code pattern acquisition department and then configurate them.
In the following step(S100), it is mentioned as personalization code configuration service methods characterized as acquiring simultaneously code pattern from off-line code book using the code pattern acquisition department and then configurate them.
In the following step(S100), it is mentioned as personalization code configuration service methods characterized as configurating codes with utilization of editing functions such as deletion from the phase of code pattern acquisition.
In the following step(S100), it is mentioned as personalization code configuration service methods characterized as configurating personalization codes with utilization of editing functions such as collaboration of code pattern saved internally in the terminal through the code pattern acquisition department that personalization information providing service provider offered.
In the following step(S100), it is mentioned as personalization code configuration service methods characterized as configurating simultaneously in the various terminals at the mean time that utilizing the first terminal, the configuration in on-line code book and configuration utilizing code pattern acquisition means in the second terminal and the third terminal could be co-related.
In the following step(S100), it is mentioned as personalization code configuration service methods characterized as providing quick-information of personalization code when personalization code is indicated on the terminal, or recorded on the code-expressing medium, or transmitted for the third party.
In the following step(S100), it is mentioned as personalization code configuration service methods characterized as configurating Personalization code for character
In the following step(S100), it is mentioned as personalization code configuration service methods characterized as configurating Personalization code for religion.
In the following step(S100), it is mentioned as personalization code configuration service methods characterized as configurating Personalization code for developing factor X and Y.
In the following step(S100), it is mentioned as personalization code configuration service methods characterized as configurating Personalization code for learning-methods
In the following step(S100), it is mentioned as personalization code configuration service methods characterized as configurating Personalization code for developing suitable learning attitude.
In the following step(S100), it is mentioned as personalization code configuration service methods characterized as configurating Personalization code for health-care.
In the following step(S100), it is mentioned as personalization code configuration service methods characterized as configurating Personalization code for the inveterate disease.
In the following step(S100), it is mentioned as personalization code configuration service methods characterized as configurating Personalization code on levels of personal taste.
In the following step(S100), it is mentioned as personalization code configuration service methods characterized as configurating Personalization code for user level.
In the following step(S100), it is mentioned as personalization code configuration service methods characterized as configurating Personalization code for personalization menu.
In the following step(S100), it is mentioned as personalization code configuration service methods characterized as configurating Personalization code for the personalization information field.
In the following step(S100), it is mentioned as personalization code configuration service methods characterized as configurating Personalization code for the delivery priority levels.
In the following step(S100, it is mentioned as personalization code configuration service methods characterized as configurating Personalization code for the number of delivery.
In the following step(S100), it is mentioned as personalization code configuration service methods characterized as configurating Personalization code for the most favorable relationship.
In the following step(S100), it is mentioned as personalization code configuration service methods characterized as configurating Personalization code for prohibiting configuration.
In the following step(S100), it is mentioned as personalization code configuration service methods characterized as configurating Personalization code for limitation confinement.
In the following step(S100), it is mentioned as personalization code configuration service methods characterized configurating the Personalization code for the mainly utilized terminal.
In the following step(S100), it is mentioned as personalization code configuration service methods characterized configurating the Personalization code for mainly utilized places.
In the following step(S100), it is mentioned as personalization code configuration service methods characterized configurating the Personalization code for urgent delivering subject.
In the following step(S100), it is mentioned as personalization code configuration service methods characterized configurating through the simple configuration functions including personalization code for simple configuration, and personalization menu code for simple configuration.

### THE EFFECT OF THIS INVENTION

While having direct access to the present code pattern is meaning to be convenience of exploring Internet information, if the personalization codes of this invention can be utilized, however the identical code is configurated, the way the most desirable information that were suitable for the personal taste, and personal personalization characteristics has been born, well-qualified services to enhance the individual desire in the personalized information society can be provided.

In addition, various Internet information are also available for those who are not acquainted with computer, delivering information can be facilitated in the form of the complete information delivery, therefore, the perfect degree to enhance various factors as a I-Centric Premium Life Organizer can be realized through increase individual competitiveness and pleasure as well as time-minimization, availability, convenience, and enjoyable state.

In addition, in stance of information provider, with the individual personalization basis, since perfect and convenient information can be provided for the most-desired customers, various benefits can distributed for many customers, at the same time, increasing the profit and downsizing the main costs except for essential cost of providing services. And compared to code-basis information providing system, code pattern is simpler, more facilitated, therefore it has more access to various information management.

### A SIMPLE EXPLANATION OF FIGURES

FIG. 1 is the configuration chart of personalization code configuration &management system [1].

FIG. 2 is the configuration chart of personalization code configuration & management system department [30].

FIG. 3 is the organization chart of customer terminal system [100] indicated above FIG. 1.

FIG. 4 is the organization chart of personalization code configuration & management department [400] indicated above FIG. 2.

FIG. 5 is the data configuration chart of request messages to process the information.

FIG. 6 is the flow chart of how to provide services on personalization code configuration.

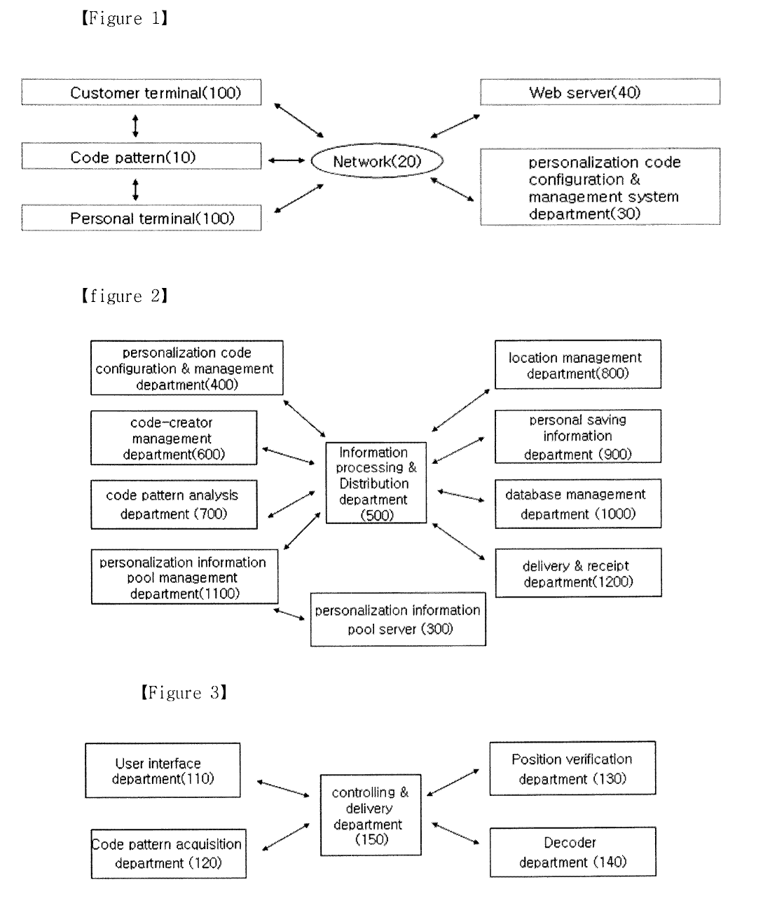

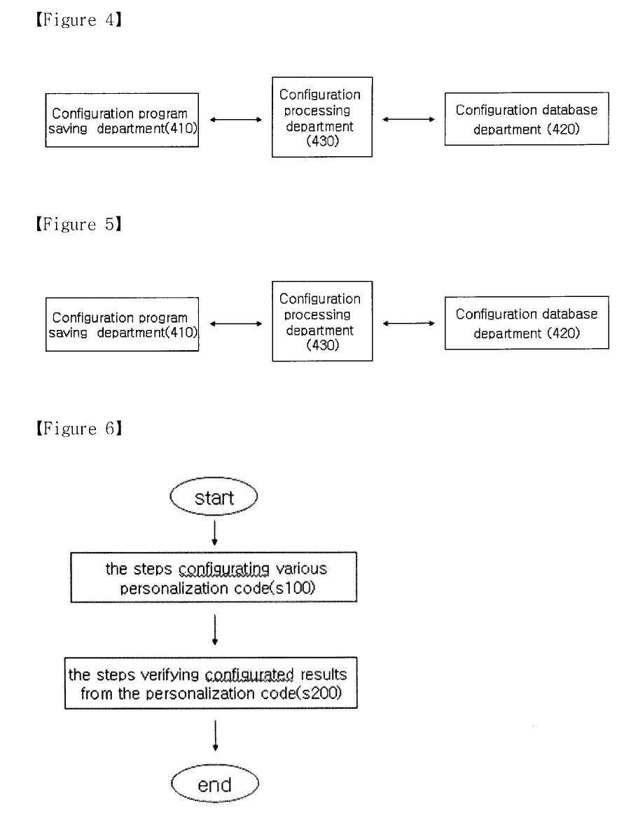

### SPECIFIC DETAILS OF A MAIN DEPARTMENT OF FIGURE

1: personalization code configuration & management system
10: code pattern
20: network
30: personalization code configuration & management system department
40: web server
50: information processing demand message
51: information processing distinguisher
52: terminal information
53: information processing related information
100: customer terminal
110: user interface department
120: code pattern acquisition department
130: position verification department
140: decoder department
150: controlling & delivery department
200: portable terminal
300: personalization information pool server
400: personalization code configuration & management department
410: configuration program saving department
420: configuration database department
430: configuration processing department
500: information processing & distribution department
600: code-creator management department
700: code pattern analysis department
800: location management department
900: personal saving information department
1000: database management department
1100: personalization information pool management department
1200: delivery & receipt department

1-36. (canceled)

37. A system configured to configure and manage a personalization code, comprising:
a customer terminal configured to obtain a code pattern, wherein:
the code pattern comprises information on at least one code from a code-expressing medium in which the code pattern is inserted,
the customer terminal is configured to configure at least one personalization code,
the customer terminal is configured to configure an on-off-line interoperation code to allow interoperation between on-line and off-line media, between terminals, and process various pieces of information, and
the customer terminal is configured to receive an information process message and information including personalization information from a personalization code configuring and managing system unit that is configured to express the personalization information; and
a web server configured to store information related to the personalization information transferred to the customer terminal in the order of priority determined according to a client-specific detailed personalization menu, wherein:
the personalization code configuring and managing system unit is configured to configure and manage individual personalization codes,
the personalization code configuring and managing system unit is configured to manage a personalization information pool and the web server,
the personalization code configuring and managing system unit is configured to generate a code including various pieces of personalization information in a form of the specific code pattern,
the personalization code configuring and managing system unit is configured to insert the code pattern in the code-expressing medium,
the personalization code configuring and managing system unit is configured to provide the code-expressing medium,
the personalization code configuring and managing system unit is configured to analyze the code pattern,
the personalization code configuring and managing system unit is configured to perform a function of managing a location of the customer terminal,
the personalization code configuring and managing system unit is configured to receive various information process request messages from the customer terminal to perform a corresponding information process,
the personalization code configuring and managing system unit is configured to transfer the personalization information to the customer terminal,
the customer terminal, the web server and the personalization code configuring and managing system unit are connected via a communication network.

38. The system of claim 37, wherein the code pattern comprises at least one of a personalization code, a product-categorizing personalization code, an information-categorizing personalization code, and the on-off-line interoperation code.

39. The system of claim 37, wherein the code pattern comprises at least one of a bar code, a radio frequency identification (RFID), an image code, a color code, and a hot code.

40. The system of claim 37, wherein the customer terminal comprises at least one of a portable terminal, a mobile communication terminal, a personal computer (PC), a notebook computer, and an Internet protocol television (IPTV) device.

41. A method of generating a personalization code using a personalization code configuring and managing system, comprising:
configuring at least one personalization code using an online codebook; and
verifying at a personalization code configuring and managing system unit the configured personalization codes.

42. The method of claim 41, wherein said configuring the personalization code comprises configuring at least one of:
a generation personalization code;
a personality personalization code;
an XY factor development personalization code;
a learning method personalization code;
a learning manner development personalization code;
a health management personalization code;
an inveterate disease management personalization code;
an inclination grade personalization code;
a use grade personalization code;
a personalization information field personalization code;
a religiosity personalization code;
a transfer priority personalization code, a transfer number personalization code;
a first degree-kinship personalization code;
a configuring-prohibition personalization code;
a limit-configuring personalization code;
a frequently-used terminal personalization code;
a frequently-used place personalization code; and
an urgent transfer object personalization code.

43. A method of configuring at least one personalization code using a personalization code configuring and managing system, comprising:
configuring said at least one personalization code using a code pattern obtained from an offline codebook by a code pattern acquisition unit of a customer terminal; and
verifying at the personalization code configuring and managing system the configured at least one personalization code.

44. The method of claim 43, wherein configuring the personalization codes comprises configuring at least one of:
a generation personalization code;
a personality personalization code;
an XY factor development personalization code;
a learning method personalization code;
a learning manner development personalization code;
a health management personalization code;
an inveterate disease management personalization code;
an inclination grade personalization code;
a use grade personalization code;
a personalization information field personalization code;
a religiosity personalization code;
a transfer priority personalization code;
a transfer number personalization code;
a first degree-kinship personalization code;
a configuring-prohibition personalization code;
a limit-configuring personalization code;
a frequently-used terminal personalization code;
a frequently-used place personalization code; and
an urgent transfer object personalization code.

45. The method of claim 43, wherein configuring the at least one personalization code comprises:
substantially continuously obtaining at the code pattern acquisition unit of the customer terminal the code pattern; and
configuring the at least one personalization code.

46. The method of claim 43, wherein said configuring the at least one personalization code comprises configuring the personalization codes using an editing function including a deleting function.

47. The method of claim 43, wherein said configuring the at least one personalization code comprises configuring the at least one personalization code using an editing function that comprises combining the obtained code pattern and a code pattern stored in the customer terminal

48. A method of configuring service method using a personalization code configuring and managing system, comprising:
configuring at least one personalization code for a plurality of terminals comprising interoperating a configuration:
at a first terminal frequently used by a customer using an online codebook having a different configuration, and
at a second terminal and a third terminal using an offline codebook; and
verifying at the personalization code configuring and managing system unit the configured at least one personalization code.

49. The method of claim 48, wherein said configuring the at least one personalization code comprises configuring at least one of:
a generation personalization code;
a personality personalization code;
an XY factor development personalization code;
a learning method personalization code;
a learning manner development personalization code;
a health management personalization code;
an inveterate disease management personalization code;
an inclination grade personalization code;
a use grade personalization code;
a personalization information field personalization code;
a religiosity personalization code;
a transfer priority personalization code;
a transfer number personalization code;
a first degree-kinship personalization code;
a configuring-prohibition personalization code;
a limit-configuring personalization code;
a frequently-used terminal personalization code;
a frequently-used place personalization code; and
an urgent transfer object personalization code.
